(19) United States
(12) Patent Application Publication
(10) Pub. No.: US 2015/0033545 A1
(43) Pub. Date: Feb. 5, 2015

(54) METHOD FOR MANUFACTURING ANTENNA PART

(71) Applicant: SUMIDA CORPORATION, Tokyo (JP)

(72) Inventors: Yasunori MORIMOTO, Tokyo (JP); Yoshiyuki HATAYAMA, Tokyo (JP)

(21) Appl. No.: 14/445,189

(22) Filed: Jul. 29, 2014

(30) Foreign Application Priority Data
Aug. 2, 2013 (JP) 2013-161219

(51) Int. Cl. G06K 19/077; H01Q 7/00

(52) U.S. Cl. CPC G06K 19/07754; G06K 19/07779; H01Q 7/00
USPC 29/601

(57) ABSTRACT

Provided is a method of manufacturing an antenna part that can be produced easily and inexpensively, the method comprising the steps of: forming a coil part 11 by a wire material 13 having an insulation coating 16, and removing the insulation coating 16 from both end portions 11a of the coil part 11; forming a connection region 12a of an electrically-conductive metal on the semiconductor substrate 12, and further forming a solder layer 14 on the connection region 12a; wiring the coil part 11 on the connection region 12a so that each end portion 11a of the coil part 11 to be in contact with the solder layer 14; and melting the solder layer 14 by heat to allow each end portions 11a to enter into the solder layer 14, and thus to electrically connect the connection region 12a and the coil part 11 through the solder layer 14.

### CROSS REFERENCE TO RELATED APPLICATIONS

The present invention claims priority under 35 U.S.C. §119 to Japanese Application No. 2013-161219 filed Aug. 2, 2013, the entire content of which is incorporated herein by reference.

### TECHNICAL FIELD

The present invention is related to a method for manufacturing an antenna part, in particular, to a method for manufacturing an antenna part which electrically connects and fixes a connection portion of a wire material drawn from a coil part of the antenna to a semiconductor substrate

### BACKGROUND ART

In general, with regard to an antenna part which is made by integrating an IC chip and a coil winding, such as an IC card for station entrance and exit, a transmission antenna for a keyless entry system of a car or a house, and the like, it is known that the IC chip and the coil winding are connected with a bonding wire.

In Japanese Laid-open Patent Application Publication No. S63-208236, a method is disclosed in which a ball is formed by arc discharging a tip of an electrically conductive wire having an insulation coating on the outside, the ball is bonded to a semiconductor substrate by applying an ultrasonic vibration.

However, in the invention disclosed in the Japanese Laid-open Patent Application Publication No. S63-208236, the end portion of the coil winding and the semiconductor substrate were not connected directly, and the coil winding was connected to the semiconductor substrate through a lead frame and a gold wire. Therefore, the number of the parts grew large, the manufacturing cost for assembling grew expensive, and thereby the production man-hours increased.

### CITATION LIST

### Patent Literature

Patent Literature 1: Japanese Laid-open Patent Application Publication No. S63-208236

### SUMMARY OF INVENTION

### Technical Problem

Thus, the present invention has been accomplished in view of the problems described above. It is an object of the present invention to provide a method for manufacturing an antenna part which can be easily made at a low cost by connecting directly an end of a coil winding and a semiconductor substrate.

### Solution to Problem

The present invention has been proposed in order to achieve the above object. An aspect according to the present invention is a method of manufacturing an antenna part having a coil part and a semiconductor substrate, the method comprising the steps of: (A) forming the coil part by a wire material having an insulation coating, and removing the insulation coating from both end portions of the coil part; (B) forming a connection region of an electrically-conductive metal on a surface of the semiconductor substrate, and further forming a solder layer on a surface of the connection region; (C) wiring the coil part on the connection region so that each end portion of the coil part to be in contact with the solder layer; and (D) melting the solder layer by heat to allow each end portion to enter into the solder layer, and thus to electrically connect the connection region and the coil part through the solder layer.

In the above aspect, the wire material is preferably a copper wire coated with one of a polyurethane and a polyimide.

In the above aspect, the solder layer is preferably formed in a thickness not less than 5 times and not more than 20 times of that of the connection region.

In the step (C) of the above aspect, the portion of the coil part in contact with the solder layer is preferably arranged to be parallel to the surface of the semiconductor substrate.

In the step (C) of the above aspect, the portion of the coil part in contact with the solder layer is preferably arranged to be inclined with regard to the surface of the semiconductor substrate.

### Advantageous Effects of Invention

According to the present invention, by directly connecting a wire material of a coil part from which an insulation coating is removed to a semiconductor substrate through a solder, it is possible to minimize the energy using for connecting a copper wire and the solder, and a bonding wire becomes unnecessary so that the improvement in productivity and price advantage characteristics can be planned.

### BRIEF DESCRIPTION OF DRAWINGS

FIG. 1 is a schematic diagram illustrating an example of an antenna part formed by connecting and fixing a semiconductor substrate and a coil part which is formed by applying the method for manufacturing according to the present invention.

FIG. 2A is an enlarged plan view of portion A in FIG. 1.

FIG. 2B is an enlarged side view of portion A in FIG. 1 as seen from the direction of arrow B in FIG. 2A.

FIG. 2C is an enlarged cross-sectional view of portion A in FIG. 1 along line C-C of FIG. 2B.

FIG. 2D is an enlarged cross-sectional view of the coil part in portion A in FIG. 1 before being connected and fixed.

FIG. 3A is a view of an antenna part illustrating from a cross-sectional direction of the coil part, in a schematic diagram of a portion of a lead wire connection device and the antenna part for carrying out the method for manufacturing the antenna part according to an embodiment of the present invention.

FIG. 3B is a side view of FIG. 3A, in the schematic diagram of a portion of the lead wire connection device and the antenna part for carrying out the method for manufacturing the antenna part according to the embodiment of the present invention.

FIG. 4 is a process diagram illustrating the method for manufacturing the antenna part according to the embodiment of the present invention.

FIG. 5 is a diagram illustrating a modification of the method for manufacturing the antenna part according to the present invention.

FIG. 6 is a diagram illustrating another modification of the method for manufacturing the antenna part according to the present invention.

### DESCRIPTION OF EMBODIMENTS

Hereinafter, an embodiment for carrying out the present invention (hereinafter, referred to as “embodiment”) shall be described with reference to the attached drawings.

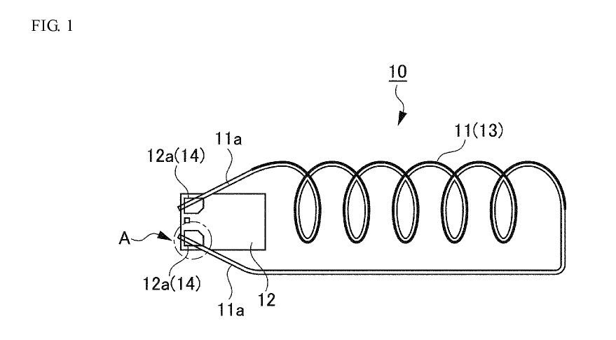

FIG. 1 is a schematic diagram illustrating an example of an antenna part which is formed by applying the method for manufacturing according to the present invention. In FIG. 1, the antenna part 10 includes a coil part 11 and a semiconductor substrate 12.

The coil part 11 is an antenna coil which is formed to a coil by winding a wire material 13 by a predetermined number of turns. At both the ends, connection end portions 11a, 11a are derived as a connection portion separately for connecting with the semiconductor substrate 12.

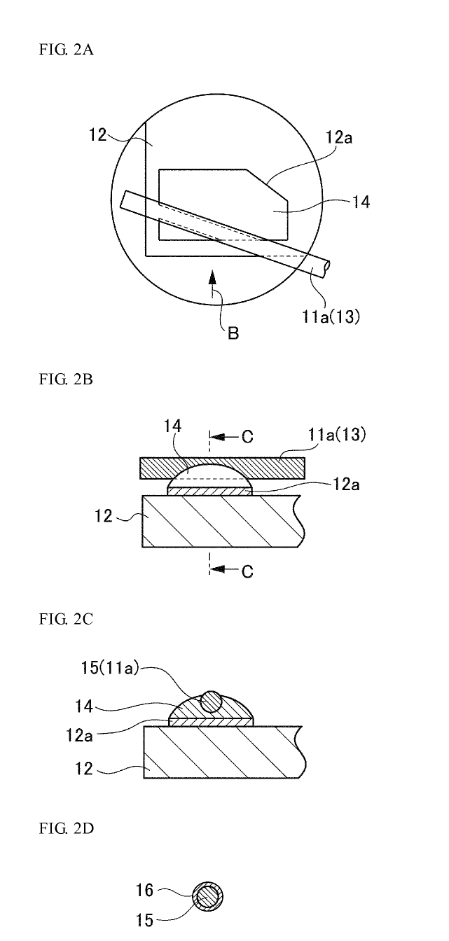

The semiconductor substrate 12 is an IC chip. Electrode terminals composed of an electrically-conductive material, that is, pads 12a, 12a, are provided on the portions thereof. FIG. A to FIG. D illustrate enlarged views of portion A including either of the pads 12a, 12a in FIG. 1. FIG. 2A is a plan view, FIG. 2B is a side view as seen from the direction of arrow B in FIG. 2A, and FIG. 2C is a cross-sectional view taken along line C-C in FIG. 2B. As illustrated in FIG. 2A to FIG. 2D, to each of the pads 12a, 12a, a core wire 15 which is a portion of each of the connection end portions 11a, 11a is fixed with a solder layer 14 and electrically connected.

In addition, a wire material 13 which forms the coil part 11, as illustrated in FIG. 2D, is composed of the core wire 15 having electrical conductivity made of copper or the like, and an insulation coating 16 coated with a polyurethane or a polyimide on the outer periphery surface of the core wire 15. The insulation coating 16 is removed after winding the coil part 11 by a method such as a chemical agent treatment, an ultraviolet light irradiation, heating, blowing off by a gas, cutting by a cutter, a laser beam irradiation, or the like. The core wire 15 from which the insulation coating 16 was removed comes to be soldered to the pads 12a, 12a of the semiconductor substrate 12.

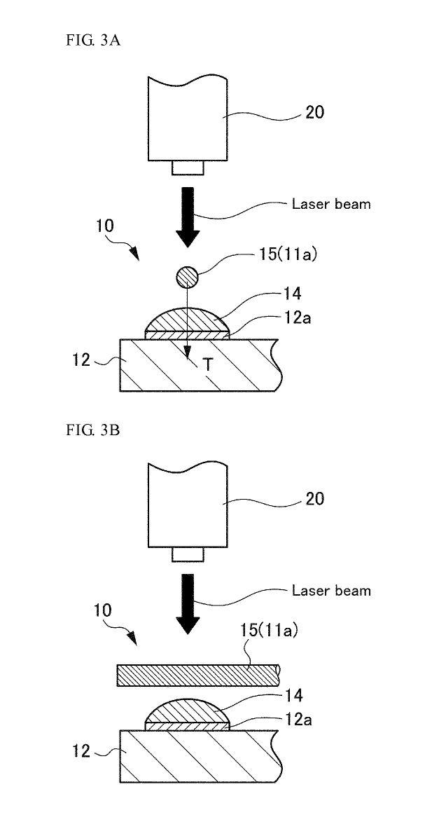

FIG. 3A and FIG. 3B illustrate the positions of a lead wire connection device 20, the coil part 11 and the semiconductor substrate 12 at connection working. FIG. 3A is a view of the antenna part 10 illustrating from a cross-sectional direction of the coil part 11, and FIG. 3B is a side view of FIG. 3A. In FIG. 3A and FIG. 3B, the lead wire connection device 20 is configured to irradiate a laser beam to the solder layer 14 as a connecting portion formed on the upper surfaces of the pads 12a, 12a which are connection regions of the semiconductor substrate 12, and during the irradiation of the laser beam, to be able to irradiate the laser beam in a state of the wire material 13 being attracted to the side of the solder layer 14, that is, the side of the pad 12a, and being given a tension T. And, when the laser beam is irradiated to the solder layer 14, the solder layer 14 absorbs the laser beam and comes to generate heat and is dissolved.

On the other hand, as described above, the wire material 13 is composed of the core wire 15 having electrical conductivity made of copper or the like, and an insulation coating 16 coated with a polyurethane or a polyimide on the outer periphery surface of the core wire 15. The insulation coating 16 is removed by a method such as a chemical agent treatment, an ultraviolet light irradiation, heating, blowing off by a gas, cutting by a cutter, a laser beam irradiation, or the like, before soldering. Here, the diameter of the core wire 15 is from 0.03 to 0.06 mm for example in the present example.

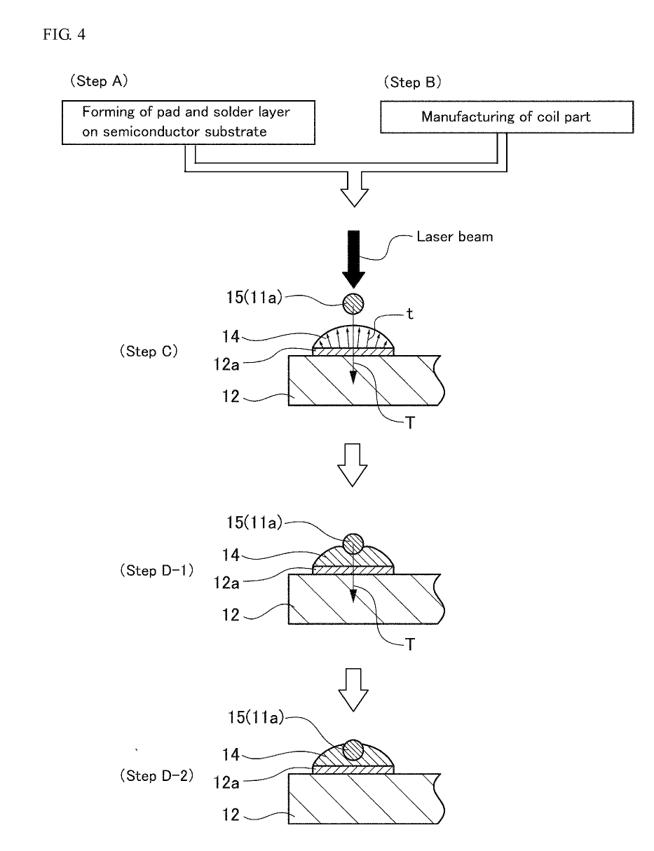

FIG. 4 illustrates an example of a sequential procedure of the steps for manufacturing the antenna part of FIG. 1A. The manufacturing steps shall be described in the order of Step A to Step D with reference to FIG. 4. Here, Step A and Step B may be executed in any order and are not limited to the alphabetical order.

First, a wire material 13 is wound into a coil shape by a predetermined number of turns, and connection end portions 11a, 11a are derived from each of the both ends in a same direction, an insulation coating 16 of each of the connection end portions 11a, 11a is removed, and a coil part 11 is formed (Step A). In addition, the connection end portions 11a, 11a are preferably derived horizontally from a lower surface side position of the coil part 11, toward outside in an extending direction of the coil part 11, so that the thickness of the connection end portions 11a, 11a can be absorbed by the height of the coiled portion.

Next, a pad (connection region) 12a composed of an electrically-conductive metal is formed on an upper surface of a semiconductor substrate 12, and further on an upper surface thereof, a solder layer 14 is formed (Step B). Here, in the present example, the thickness of the pad 12a is 0.006 mm and the thickness of the solder layer is 0.06 to 0.10 mm, and the thickness of the solder layer is formed so as to be 5 to 20 times the thickness of the pad 12a.

Next, the coil part 11 and the semiconductor substrate 12 are set to a lead wire connection device 20, and the portions of the connection end portions 11a, 11a derived from the coil part 11 are, as illustrated in FIG. 3A and FIG. 3B, disposed on the solder layer 14 so as to be in contact therewith, in the state parallel to the upper surface of the pad (connection region) 12a of the semiconductor substrate 12. In this case, with regard to the coil part 11, in a state that a force to attract each of the connection end portions 11a, 11a to the side of the pad 12a, that is a tension T to the connection end portions 11a, 11a is applied, the connection end portions 11a, 11a are disposed on the solder layer 14 which is provided on the pad 12a of the semiconductor substrate 12, and then a laser beam 14 is irradiated toward the solder layer 14 (Step C). Here the sign “t” is a reaction force acting on the core wire 15 (wire material 13) from the solder layer 14.

In this way, the laser beam is irradiated to the solder layer 14, in the state that the tension T is applied so that the connection end portion 11a is attracted to the pad 12a, the solder layer 14 absorbs the laser beam and heat is generated. And the solder layer 14 begins to dissolve by the heat (Step D-1).

Further, in this way, by the continuous irradiation of the laser beam to the solder layer 14, due to the tension “T” which attracts the connection end portion 11a of the wire material 13 to the pad 12a, and the reaction force “t”, the exposed core wire 15 sinks into the solder layer 14, and the outer periphery surface of the core wire 15 comes to be covered with the solder layer 14. Further then, by stopping the irradiation of the laser beam to cool and solidify the solder layer 14, connecting and fixing between the core wire 15 of the wire material 13 and the pad 12a is completed (Step D-2).

Thus, by carrying out the process of Step A to Step D, connecting and fixing between the core wire 15 and the solder layer 14 is performed ensuring the electrical conductivity. As a result, connecting and fixing between the core wire 15 and the solder layer 14 can be made reliably.

Note that the solder layer 14 may be of any material as long as the material easily absorbs the laser beam. For example, a material such as tin only, containing tin or the like may be possible.

Further, the laser beam may be any one of a solid-state laser, a gas laser, and a liquid laser, such as a carbon dioxide gas laser, semiconductor laser, an Excimer Laser, a YAG laser, and the like, for example.

Further, in the present embodiment, the laser beam is used for removing the insulation coating 16. In that case, for the portion of the insulation coating on the wire material 13 to which the laser beam is irradiated directly, it is preferable to use a wire material 13 having the insulation coating 16 of blue color or green color so that the insulation coating is easily peeled off, but another color such as a natural color (daytime white), or the like may be possible.

Further, the case that the solder layer 14 is provided on the pad 12a by coating or the like has been described, but the solder layer 14 may be provided on the outer periphery surface of the wire material 13 by coating or the like, or on both the pad 12a and the outer periphery surface of the wire material 13.

Further, the case that the tension “T” is applied so as to attract the wire material 13 to the pad 12a has been described, but the tension may be applied so as to attract the wire material 13 to the wire material 13 conversely.

Further, in the above described example, a description has been made for the case where the portions of the connection end portions 11a, 11a derived from the coil part 11 are disposed on the solder layer 14 so as to be in contact therewith in the state parallel to the upper surface of the pad 12a of the semiconductor substrate 12, and in this state, are connected to the connection end portions 11a, 11a by applying the tension “T”. In the case where the connection end portion 11a and the pad 12a are connected through melting the solder, disposing the connection end portion 11a to be parallel to the surface of the pad 12a in this way, the connection area of the connection end portion 11a and the pad 12a, that is, the sinking area of a portion of the connection end portion 11a into the pad 12a increases, and more reliable connection becomes possible.

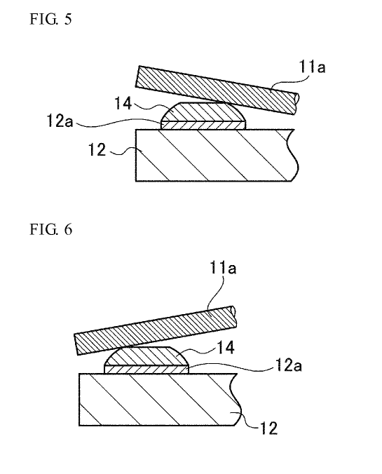

However, as illustrated in FIG. 5 and FIG. 6, it may be possible to dispose the connection end portions 11a, 11a derived from the coil part 11 on the solder layer 14 so as to be in contact therewith respectively, in the state the connection end portions 11a, 11a are inclined with regard to the upper surface of the pad (connection region) 12a, that is, in the state the connection end portions 11a, 11a are inclined toward the rear side (the side of the coil part 11) in FIG. 5, and in the state the connection end portions 11a, 11a are inclined toward the front side in FIG. 6. In this state, the connection end portions 11a, 11a may be connected with adding the tension “T”. In this case, the freedom of the positions of the connection end portions 11a, 11a derived from the coil part 11 increases.

According to the above described embodiment, the effect is described as follows. That is, the above described embodiment according to the present invention is a method of manufacturing an antenna part having a coil part and a semiconductor substrate, the method comprising the steps of: (A) forming the coil part by a wire material having an insulation coating, and removing the insulation coating from both end portions of the coil part; (B) forming a connection region of an electrically-conductive metal on a surface of the semiconductor substrate, and further forming a solder layer on a surface of the connection region; (C) wiring the coil part on the connection region so that each end portion of the coil part to be in contact with the solder layer; and (D) melting the solder layer by heat to allow each end portion to enter into the solder layer, and thus to electrically connect the connection region and the coil part through the solder layer.

In the above described embodiment, the wire material is preferably a copper wire coated with one of a polyurethane and a polyimide. According to this, when the copper wire is used as the core material and the outer surface thereof is covered with an insulation coating of a polyurethane or a polyimide, the insulation coating can be easily dissolved and peeled off by irradiating a laser beam, and so the electrical conduction between the core wire and the connection region can be ensured.

In the above described embodiment, the solder layer is preferably formed in a thickness not less than 5 times and not more than 20 times of that of the connection region. Assuming that the diameter of the wire material is approximately 0.03 to 0.06 mm and the thickness of the pad is approximately 0.006 mm, the thickness of the solder layer becomes 0.06 to 0.10 mm. When the solder layer is dissolved, the amount of the wire material which sinks into the solder layer can be taken large, and the connecting and fixing can be performed more reliably. Further, by increasing the thickness of the solder layer, the core portion of the wire material becomes not to be in contact with the semiconductor substrate and the connection region, the damage of the semiconductor substrate and the connection region exerted by the core portion can be reduced.

In the Step (C) of the above described embodiment, the portion of the coil part in contact with the solder layer is preferably arranged to be parallel to the surface of the semiconductor substrate. According to this, in the case where the connection portion of the coil part is arranged to be parallel with regard to the surface of the semiconductor substrate, and the connection portion is connected to the dissolved solder layer, the connection area of the connection portion of the coil part and the connection region (pad) on the side of the semiconductor substrate, that is, the area that the connection portion sinks into the solder layer becomes larger and a more reliable connection becomes possible. Further, the risk that the core portion of the wire material contacts with the semiconductor substrate and the connection region can be reduced.

In the Step (C) of the above embodiment, the portion of the coil part in contact with the solder layer is preferably arranged to be inclined with regard to the surface of the semiconductor substrate. According to this, the freedom of the position of the connection portion derived from the coil part increases.

Note that in addition to the above description, various modification can be made to the present invention without departing from the spirit of the present invention, it is natural that the present invention extends to the modifications.

### REFERENCE SIGNS LIST

10 . . . antenna part, 11 . . . coil part (antenna coil), 11a . . . connection end portion, 12 . . . semiconductor substrate (IC chip), 12a . . . pad (connection region), 13 . . . wire material, 14 . . . solder layer, 15 . . . core wire, 16 . . . insulation coating, 20 . . . lead wire connection device, T . . . tension, t . . . reaction force

1. A method of manufacturing an antenna part having a coil part and a semiconductor substrate, the method comprising the steps of:
(A) forming the coil part by a wire material having an insulation coating, and removing the insulation coating from both end portions of the coil part;
(B) forming a connection region of an electrically-conductive metal on a surface of the semiconductor substrate, and further forming a solder layer on a surface of the connection region;
(C) wiring the coil part on the connection region so that each end portion of the coil part to be in contact with the solder layer; and
(D) melting the solder layer by heat to allow each end portion to enter into the solder layer, and thus to electrically connect the connection region and the coil part through the solder layer.

2. The method according to claim 1, wherein the wire material is a copper wire coated with one of a polyurethane and a polyimide.

3. The method according to claim 1, wherein the solder layer is formed in a thickness not less than 5 times and not more than 20 times of the connection region.

4. The method according to claim 2, wherein the solder layer is formed in a thickness not less than 5 times and not more than 20 times of the connection region.

5. The method according to any one of claims 1, wherein in the Step (C), the portion of the coil part in contact with the solder layer is arranged to be parallel to the surface of the semiconductor substrate.

6. The method according to any one of claims 1, wherein in the Step (C), the portion of the coil part in contact with the solder layer is arranged to be inclined with regard to the surface of the semiconductor substrate.
